(19) United States
(12) Patent Application Publication
(10) Pub. No.: US 2022/0074661 A1
(43) Pub. Date: Mar. 10, 2022

(54) FREEZE DRYING WITH CONSTANT-PRESSURE AND CONSTANT-TEMPERATURE PHASES

(71) Applicant: Stay Fresh Technology, LLC, Los Angeles, CA (US)

(72) Inventor: Tonghu Jiang, Los Angeles, CA (US)

(21) Appl. No.: 17/015,762

(22) Filed: Sep. 9, 2020

(51) Int. Cl. F26B 5/06

(52) U.S. Cl. CPC F26B 5/06

(57) ABSTRACT

Freeze-drying methods and systems include performing a constant-pressure drying phase in a chamber, where a temperature of a heating tray increases. A constant-temperature drying phase is performed in the chamber, where a pressure in the chamber decreases. Additional phases alternate between constant-pressure drying phases and constant-temperature drying phases. The alternating drying phases are halted, responsive to a determination that the temperature of the heating tray has reached a maximum temperature.

### BACKGROUND OF THE INVENTION

The present invention relates to freeze drying, and, more particularly, to freeze drying with alternating periods of constant pressure and constant temperature.

Freeze drying is a process by which water is removed from a substance by sublimation. Whereas evaporation removes liquid water and turns it into a gas, sublimation removes solid ice and converts the ice directly to a gas, without first passing through a liquid phase. This is possible at certain ranges of temperature and pressure, where a sufficiently low pressure allows relatively warm water molecules in ice to escape directly to the surrounding environment, without first melting ice.

Freeze drying can therefore be used to stabilize and preserve certain substances, which might otherwise spoil if kept in a hydrated state. Additionally, the process can be performed quickly, and more completely, relative to drying by evaporation, with less of a risk of contamination or damage to the substance.

### BRIEF SUMMARY OF THE INVENTION

A method includes performing a constant-pressure drying phase in a chamber, where a temperature of a heating tray increases. A constant-temperature drying phase is performed in the chamber, where a pressure in the chamber decreases. Additional phases alternate between constant-pressure drying phases and constant-temperature drying phases. The alternating drying phases are halted, responsive to a determination that the temperature of the heating tray has reached a maximum temperature.

A system includes a vacuum chamber and a vacuum pump, configured to evacuate the vacuum chamber. A heating tray is positioned within the vacuum chamber. A controller is configured to control the heating tray to perform a constant-pressure drying phase in a chamber, where a temperature of the heating tray increases, to perform a constant-temperature drying phase in the chamber, where a pressure in the chamber decreases, to alternate between additional constant-pressure drying phases and additional constant-temperature drying phases, and to halt the alternating drying phases responsive to a determination that the temperature of the heating tray has reached a maximum temperature.

A system includes a vacuum chamber and a vacuum pump, configured to evacuate the vacuum chamber. A heating tray is positioned within the vacuum chamber. A temperature sensor is configured to measure a temperature of the heating tray. A pressure sensor is configured to measure a pressure of the vacuum chamber. A controller is configured to control the heating tray to perform a constant-pressure drying phase in a chamber, where the temperature of the heating tray increases, by activating the heating tray to cause a sample sublimation rate to match a combined evacuation rate and condensation rate, to perform a constant-temperature drying phase in the chamber, where pressure in the chamber decreases, by activating the heating tray to compensate for heat loss due to sample sublimation, to alternate between additional constant-pressure drying phases and additional constant-temperature drying phases, to halt the drying phases responsive to a determination that a maximum temperature has been reached, and to perform a final phase, after halting the drying phase, where pressure in the vacuum chamber decreases to a terminal value.

These and other features and advantages will become apparent from the following detailed description of illustrative embodiments thereof, which is to be read in connection with the accompanying drawings.

### BRIEF DESCRIPTION OF THE DRAWINGS

The disclosure will provide details in the following description of preferred embodiments with reference to the following figures wherein:

FIG. 1 is a diagram of a freeze drying system that is configured to alternate between constant-pressure and constant-temperature drying phases, in accordance with an embodiment of the present principles;

FIG. 2 is a block/flow diagram of a method for freeze-drying a sample using alternating constant-pressure and constant temperature drying phases in a fixed-period mode, in accordance with an embodiment of the present principles;

FIG. 3 is a block/flow diagram of a method for freeze-drying a sample using alternating constant pressure and constant temperature drying phases in a threshold-triggered mode, in accordance with an embodiment of the present principles;

FIG. 4 is a block/flow diagram of a method for controlling the heater in a freeze-drying system during either a constant-pressure drying phase or a constant-temperature drying phase, in accordance with an embodiment of the present principles;

FIG. 5 is a block diagram of a freeze dryer control system that is configured to control a heating tray within a vacuum chamber to perform a freeze-drying process, in accordance with an embodiment of the present principles;

FIG. 6 is a graph that illustrates exemplary temperature curves of a freeze-drying process, in accordance with an embodiment of the present principles;

FIG. 7 is a graph that illustrates exemplary pressure curves of a freeze-drying process, in accordance with an embodiment of the present invention.

### DETAILED DESCRIPTION

Embodiments of the present invention provide methods and systems for freeze drying substances. The present embodiments make use of a drying cycle that includes an iterative process of increasing temperature and decreasing pressure. During periods of increasing temperature, the pressure is held constant, and during periods of decreasing pressure, the temperature is held constant. The present embodiments may control the temperature of a substance, during the freeze drying process, to control the rate of sublimation and, thereby, to control the overall pressure.

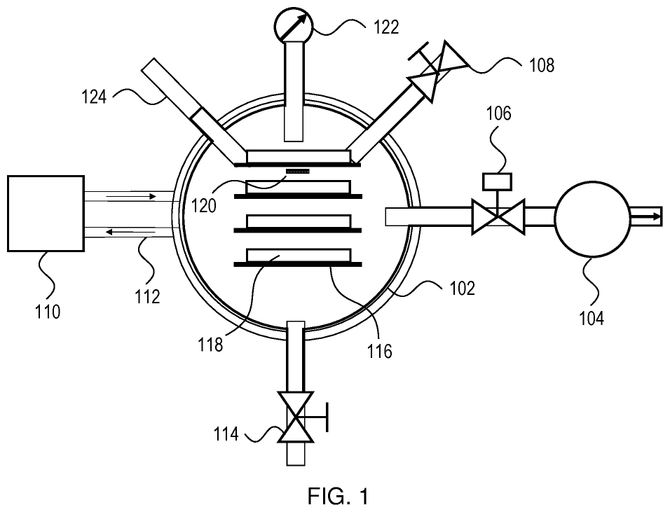

Referring now to the drawings, in which like numerals represent the same or similar elements, and initially to FIG. 1, an exemplary freeze drying apparatus is shown. A vacuum chamber 102 is shown, with a vacuum pump 104 being controlled by a vacuum valve 106. When the vacuum valve 106 is open, the vacuum pump 104 pumps gases out of the vacuum chamber 102. The vacuum valve 106 may be manually operated, or may be motorized, to control whether the vacuum pump 104 is working on the vacuum chamber 102 at any given time. A vacuum release valve 108 provides an inlet for reintroducing pressure to the vacuum chamber 102, and may similarly be automatically or manually controlled.

A condenser 110 cools a coolant fluid in coolant pipes 112. These coolant pipes 112 run through or around the walls of the vacuum chamber 102, providing a low-temperature inner surface for the vacuum chamber 102. As sublimated water vapor in the vacuum chamber 102 encounters the cold surface of the vacuum chamber 102, the water condenses. During drying, the temperature of the interior face of the vacuum chamber 102 can become quite cold—for example −40° C.—such that the sublimated water vapor forms ice upon condensation. After drying, the ice can melt during a defrosting phase, with the water dripping through drain valve 114.

One or more heating trays 116 are positioned in the vacuum chamber 102, and may hold samples 118. The samples 118 can be formed from any appropriate substance that includes water. The samples 118 are dehydrated through the freeze drying process. The heating trays 116 apply heat to the samples 118 by convection and conduction, and can be controlled to determine how much heat is added. At relatively high pressures, the heat transfer is dominated by convection, while, at low pressures, the heat transfer is dominated by conduction. In some embodiments, the heating trays may have a power output in the range between about 90 W and about 150 W.

In some embodiments, the heating trays 116 have a simple on/off function, with the amount of heat being determined by a duration that the heating trays 116 are turned on. The temperature of the samples 118 can be controlled by controlling the duration and frequency of heating. It is specifically contemplated that the heating trays 116 may include resistive heating elements, which generate heat responsive to a current passing through them. Thus, applying a voltage to the heating trays 116 may put the trays in an “on” state, while turning the voltage off may put the trays in an “off” state.

A temperature sensor 120 provides information regarding the temperature of the samples 118, and may be positioned on, next to, or within one or more of the samples 118. A vacuum sensor pressure 122 measures the pressure within the vacuum chamber 102. The information provided by these sensors can be used, as described in greater detail below, to control the freeze drying process. A cabling inlet 124 may provide for communication between the sensors and an external control system. In some embodiments, the control system may alternatively be positioned within the vacuum chamber 102, or may otherwise be integrated with the vacuum chamber 102.

The present embodiments include multiple distinct modes for controlling the freeze drying process. In a first, mode, each constant temperature cycle and each constant pressure cycle runs for a fixed, predetermined period of time. In a second, threshold-triggered mode, each constant temperature cycle continues until a threshold temperature is reached, and each constant-pressure cycle continues until a pressure threshold is reached. It should be noted that the terms, “constant temperature,” and, “constant pressure,” may be approximate. In practical embodiments, the “constant temperature” may be obtained by turning heating trays 116 on and off, with a period that is selected to keep the temperature within a predetermined range of a target temperature. Similarly, the “constant pressure” may be obtained by turning the heating trays 116 on and off, thereby managing the sublimation rate to keep the pressure within a predetermined range of a target pressure, for example by compensating for the rate at which water vapor is removed by evacuation by condensation. In some embodiments, the period for controlling the tray may be between about 10 s and about 30 s.

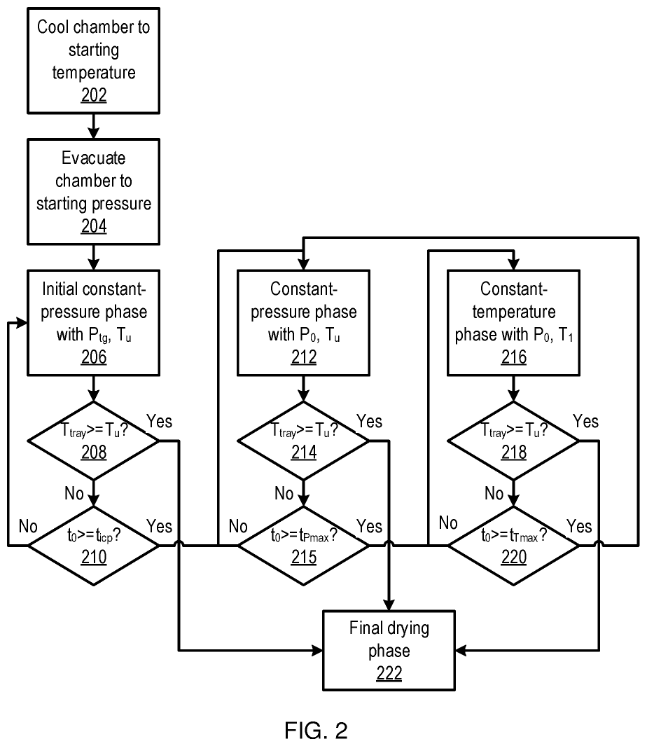

Referring now to FIG. 2, a method for controlling a freeze drying process in a fixed-period mode is shown. Block 202 begins by cooling the vacuum chamber 102 to a starting temperature, for example about −30° C. This can be performed, for example, by turning on the condenser 110 and waiting for a predetermined time, or waiting until the temperature measured by temperature sensor 120 reaches a predetermined value. Block 204 evacuates the vacuum chamber 102 to a starting pressure, for example below about 60-70 pascal. This can be performed, for example, by turning on the vacuum pump 104 and waiting until the pressure measured by pressure sensor 122 reaches a predetermined value.

Block 206 performs an initial constant-pressure phase, during which the temperature in the vacuum chamber 102 increases, but the pressure is kept roughly constant. The details of the constant-pressure phases and the constant-temperature phases will be described in greater detail below. This phase continues until block 208 determines that the temperature of the tray T_{tray} meets or exceeds a maximum temperature Tᵤ, or until block 210 determines that the time of the phase t₀ exceeds a maximum initial constant pressure phase time t_{icp}, for example between about 15 minutes and about 60 minutes. In some embodiments, the maximum tray temperature Tᵤ may be between about 30° C. and about 60° C., with a specifically contemplated value being about 45° C. Tᵤ is selected to prevent destruction of the sample. For example, if proteins are being freeze dried, and if the proteins denature at 40° C., then the maximum temperature may be set at, or just below, 40° C.

If block 210 finds that t_{icp} has been exceeded, block 212 begins a new constant-pressure phase, with new parameters, including the pressure at the beginning of the phase P₀ and the maximum tray temperature Tᵤ. During this phase, the temperature increases in the vacuum chamber 102, while the pressure is kept roughly constant. The new constant-pressure phase continues until block 214 determines that the tray temperature T_{tray} has exceeded the maximum tray temperature Tᵤ, or until block 215 determines that the time in the new constant-pressure phase has exceeded a maximum constant pressure phase time t_{Pmax}, for example between about 15 minutes and about 60 minutes.

If block 215 finds that t_{Pmax} has been exceeded, block 216 beings a new constant-temperature phase, with parameters that include the target pressure from the previous phase P₀, and the temperature at the start of the phase, T₁. During this phase, the pressure in the vacuum chamber 102 increases, while the temperature is kept roughly constant. The new constant-temperature phase continues until block 218 determines that the tray temperature T_{tray} has exceeded the maximum tray temperature Tᵤ, or until block 220 determines that the time in the new constant-temperature phase has exceeded a maximum constant temperature phase time t_{Tmax}, for example between about 15 minutes and about 60 minutes.

If block 220 finds that t_{Tmax} has been exceeded, processing returns to block 212 for another new constant-pressure phase, with updated parameters. The constant-pressure phases and constant-temperature phases alternate, until one of block 214 or block 218 breaks the cycle.

If any of blocks 208, 214, or 218 determines that T_{tray} has exceeded the maximum tray temperature Tᵤ, then a final drying phase 222 begins, with parameters that include target vacuum pressure P_{tg} and the maximum tray temperature Tᵤ. The final drying phase 222 continues until a predetermined condition has been reached. In some embodiments, the condition may include a sensed vacuum pressure that is below a threshold value, for example below a threshold that may be in a range between about 110 microns and about 150 microns, with a specifically contemplated example being 130 microns. At that point, the freeze drying process is complete. The pressure valve 108 may be opened to normalize pressure inside the vacuum chamber 102, and the freeze-dried samples 118 may be removed.

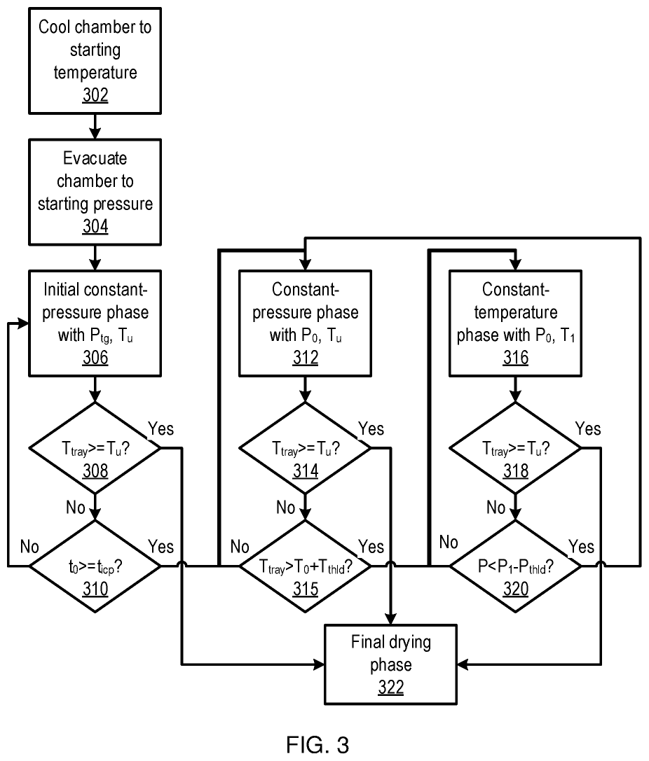

Referring now to FIG. 3, a method for controlling a freeze drying process in a threshold-triggered mode is shown. In the threshold-triggered mode, the constant-pressure and constant-temperature phases each continue until their respective measurement (pressure or temperature) has changed by a threshold amount from its value at the beginning of the phase.

As in the fixed-period mode, block 302 begins by cooling the vacuum chamber 102 to a starting temperature. This can be performed, for example, by turning on the condenser 110 and waiting for a predetermined time, or waiting until the temperature measured by temperature sensor 120 reaches a predetermined value. Block 304 evacuates the vacuum chamber 102 to a starting pressure. This can be performed, for example, by turning on the vacuum pump 104 and waiting until the pressure measured by pressure sensor 122 reaches a predetermined value.

Block 306 performs an initial constant-pressure phase, during which the temperature in the vacuum chamber 102 increases, but the pressure is kept roughly constant. The details of the constant-pressure phases and the constant-temperature phases will be described in greater detail below. This phase continues until block 308 determines that the temperature of the tray T_{tray} meets or exceeds a maximum temperature Tᵤ, or until block 310 determines that the time of the phase t₀ exceeds a maximum initial constant pressure phase time t_{icp}.

If block 310 finds that t_{icp} has been exceeded, block 312 begins a new constant-pressure phase, with new parameters, including the pressure at the beginning of the phase P₀ and the maximum tray temperature Tᵤ. During this phase, the temperature increases in the vacuum chamber 102 increases, while the pressure is kept roughly constant. The new constant-pressure phase continues until block 314 determines that the tray temperature T_{tray} has exceeded the maximum tray temperature Tᵤ, or until block 315 determines that the temperature has increased by an amount T_{thld} from the temperature at the start of the phase T₀.

If block 315 finds that the temperature has increased by at least the threshold amount T_{thld}, block 316 beings a new constant-temperature phase, with parameters that include the target pressure from the previous phase P₀, and the temperature at the start of the phase, T₁. During this phase, the pressure in the vacuum chamber 102 increases, while the temperature is kept roughly constant. The new constant-temperature phase continues until block 318 determines that the tray temperature T_{tray} has exceeded the maximum tray temperature Tᵤ, or until block 320 determines that the pressure has decreased by an mount P_{thld} from the pressure at the start of the phase P₁.

In some embodiments, T_{thld} may be between about 2° C. and about 5° C. For P_{thld}, the actual pressure measurements and threshold values may be handled as voltages, relating to the output voltage of the pressure sensor 122, rather than handling the values in units of pressure. For example, a difference of 0.5V in the pressure sensor reading may correspond to an exemplary 500 microns of actual pressure. To keep the system at 500 microns, the target pressure measurement voltage value may be set to, e.g., 0.568V. The voltage reading may be non-linear with the actual pressure. Thus, 0.5V, 0.4V, and 0.3V may correspond to 500 microns, 1500 microns, and 4500 microns, respectively. Thus, while P_{thld} may be a constant in voltage-space, for example ranging from 0.0125V to about 0.125V, this number may not correspond to a consistent pressure value. A particularly contemplated voltage value for P_{thld} is 0.0375V, but it should be understood that other values are also contemplated.

If block 320 finds that the pressure has decreased by at least the threshold amount P_{thld}, processing returns to block 312 for another new constant-pressure phase, with updated parameters. The constant-pressure phases and constant-temperature phases alternate, until one of block 314 or block 318 breaks the cycle.

If any of blocks 308, 314, or 318 determines that T_{tray} has exceeded the maximum tray temperature Tᵤ, then a final drying phase 322 begins, with parameters that include target vacuum pressure P_{tg} and the maximum tray temperature Tᵤ. The final drying phase 322 continues until a predetermined condition is reached. In some embodiments, the condition may include a sensed vacuum pressure that is below a threshold value, for example below a threshold that may be in a range between about 110 microns and about 150 microns, with a specifically contemplated example being 130 microns. Once the condition has been reached, the freeze drying process is complete. The pressure valve 108 may be opened to normalize pressure inside the vacuum chamber 102, and the freeze-dried samples 118 may be removed.

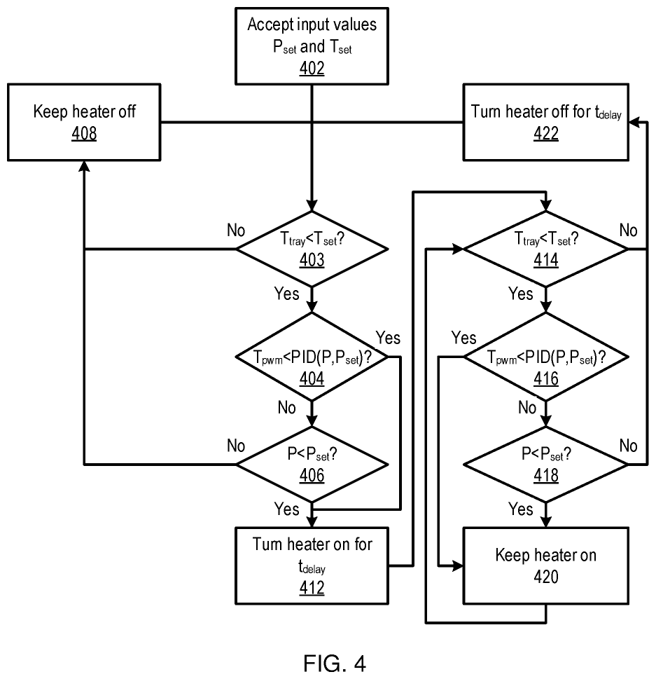

Referring now to FIG. 4, a process is shown for performing a constant-pressure or constant-temperature phase, as described above in blocks 206, 212, 216, 306, 312, and 316. Block 402 initializes input variables Pₛₑₜ and Tₛₑₜ. Thus, for example, when block 206 begins the initial constant-pressure phase, using parameters P_{tg} and Tᵤ, block 402 sets Pₛₑₜ=P_{tg}, and Tₛₑₜ=Tᵤ. Notably, the same logic is used to control both the constant-pressure and constant-temperature phases of operation.

During sublimation, the temperature of the sample 118 will tend to increase, while the temperature of the tray 116 will drop from heat transfer to the cold interior surface of the vacuum chamber 102. Block 403 determines whether the tray temperature T_{tray} is below the input temperature Tₛₑₜ. If the temperature is above the input temperature, then block 408 keeps the heating of the tray 116 off, and processing returns to block 403.

If T_{tray} is below Tₛₑₜ, then block 404 determines whether a repeating timer t_{pwm} is less than the output of a proportional-integral-derivative (PID) controller, which takes the current pressure P and the input pressure Pₛₑₜ as inputs. A PID controller provides a control loop that calculates an error value, as the difference between the measured P and the set point Pₛₑₜ, outputs a correction value, and applies a correction based on proportional, integral, and derivative terms. The PID controller attempts to minimize the difference between P and Pₛₑₜ by adjusting a proportion of the time that the heater 116 is turned on. In some embodiments, the PID may continuously output a number between, for example, 0 and 90, with a repeating timer t_{pwm} running between 0 and 90 seconds. When the number of seconds on the t_{pwm} timer is smaller than the PID output, the heater 116 may be turned on. If the number of seconds on the t_{pwm} timer equals or exceeds the PID output, the heater 116 may be turned off.

Thus, block 406 determines whether the pressure P is less than Pₛₑₜ. If both blocks 404 and 406 indicate a negative output, then block 408 keeps the heater turned off. If either of blocks 404 and 406 indicates a positive output, then block 412 turns on the heater for a predetermined period of time t_{delay}, for example about 10 seconds, with an exemplary range for t_{delay} being between about 10 s and about 20 s.

Processing then turns to block 414, which determines again whether the tray temperature T_{tray} is lower than the input temperature Tₛₑₜ. If not, block 422 turns the heater off for a period of Time t_{delay}. It should be noted that it is specifically contemplated that the time delays of blocks 412 and 422 may be the same, as shown, but these time periods may also differ as appropriate.

If T_{tray} is not less than Tₛₑₜ, then blocks 416 and 418 make determinations similar to those of blocks 404 and 406. If either block outputs a positive result, then block 420 keeps the heater on and processing returns to block 414. If both blocks output a negative result, then block 422 turns the heater off for the time period t_{delay}, and processing returns to block 403.

The input pressure Pₛₑₜ and temperature Tₛₑₜ will determine the behavior of this process, keeping the system in either a constant-pressure or constant-temperature state. The loop continues until an externally determined condition is reached, such as those shown in blocks

As sublimation occurs, an object undergoing sublimation will tend to increase in temperature over time, as the sublimation surface decreases through the loss of water to a vaporous state. As the sublimation surface decreases, so too does the rate of sublimation, and thus the rate of heat loss to sublimation also drops, leading to heat buildup within the sample. At the same time, the lower rate of sublimation leads to less water vapor being released into the vapor chamber 102, resulting in a lower pressure in the vapor chamber 102.

The present embodiments therefore make use of the heater to balance between these two processes. Turning the heater on infrequently will allow the temperature of the tray to stay constant, while the pressure in the vacuum chamber decreases. Turning on the heater more frequently will promote faster sublimation, causing additional water vapor to be released, thus making it possible to keep the pressure constant, while the temperature rises.

The sublimation rate is driven by the temperature difference between the sample 118 and the heating tray 116. When the tray temperature is kept constant, for example during a constant-temperature phase, the sublimation rate tends to decrease. This occurs because the sample sublimation surface decreases over time and because the temperature difference, which drives heat transfer and thus sublimation rate, goes down as the sample temperature increases. The lower sublimation rate leads to a lower system pressure. With more frequent heating, the tray temperature rises and heat transfer to the sample increases, thereby increasing the sublimation rate, which makes it possible to keep the system at a constant pressure.

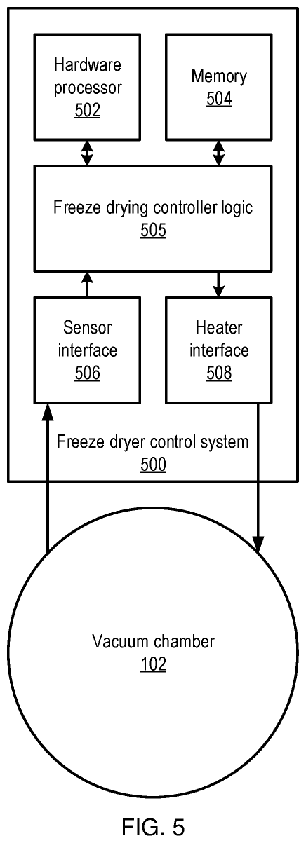

Referring now to FIG. 5, a freeze dryer control system 500 is shown, interfacing with a vacuum chamber 102 and associated apparatuses. The control system 500 may include a hardware processor 502 and a memory 504. Freeze drying controller logic 505 receives sensor information from temperature sensor 120 and pressure sensor 122 via a sensor interface 506. Based on the received sensor information, the freeze drying controller logic 505 sends instructions to a heater interface 508 to control the heating trays 116, for example using the logic described above. In some embodiments, the heater interface 508 may be implemented as a set of relays. The set of relays may receive signals from the controller logic 505 to turn the heating trays 116 on and off. The set of relays may further be used to control the operation of the condenser 110, the vacuum pump 104, and the valves.

It should be understood that the freeze drying controller logic 505 may, in some embodiments, be implemented as software that is stored in the memory 504 and that is executed by the hardware processor 502. In other embodiments, the freeze drying controller logic 505 may be implemented in the form of discrete hardware components, for example as an application-specific integrated chip or field programmable gate array.

The sensor interface 506 can communicate with the sensors by any appropriate wired or wireless medium and protocol. In some embodiments, the sensor interface 506 may receive sensor values directly as, e.g., voltages output by the respective sensors, and may convert these voltages to meaningful units. In other embodiments, the sensor interface 506 may receive pre-processed sensor values from the respective sensors, communicated via a network interface. The heater interface 508 may provide a voltage to heating elements in the heating trays 116. In other embodiments, the heater interface 508 may provide instructions to a separate heating component that, in turn, controls a voltage to the heating trays 116.

As noted above, the freeze dryer control system 500 may be integrated with the vacuum chamber 102, or may be positioned within the vacuum chamber 102, or may alternatively be positioned outside the vacuum chamber 102 in any appropriate housing, with appropriate communication leads between the system 500 and the components within the vacuum chamber 102.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The present embodiments may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

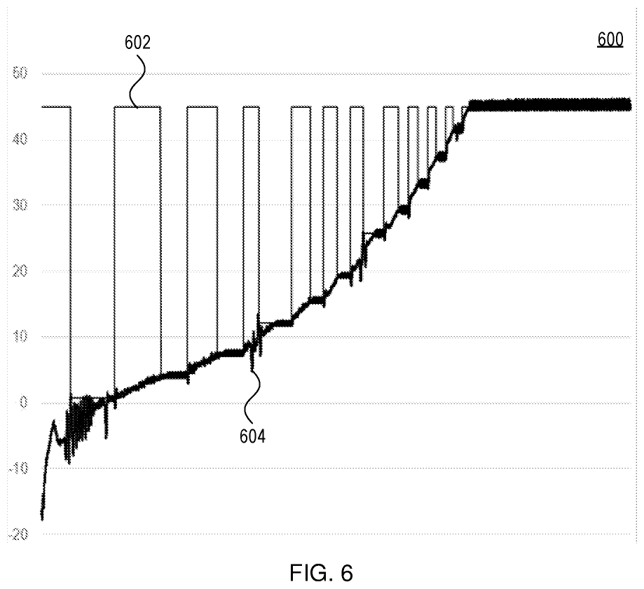

Referring now to FIG. 6, a graph 600 with an exemplary temperature curve is shown for a freeze drying process. The vertical axis shows temperature, in units of Celsius, and the horizontal axis marks time, with increasing time going from left to right. The set temperature 602 at various phases is shown, as is the measured temperature 604. During constant-pressure phases, the set temperature 602 is relatively high, for example being set to the maximum temperature value, allowing the measured temperature 604 to rise. During constant-temperature phases, the set temperature 602 is set at a recently measured temperature value, and the temperature is kept relatively constant during those time periods. Eventually, the maximum temperature is reached, and the temperature is maintained at a constant temperature value until the drying process is complete.

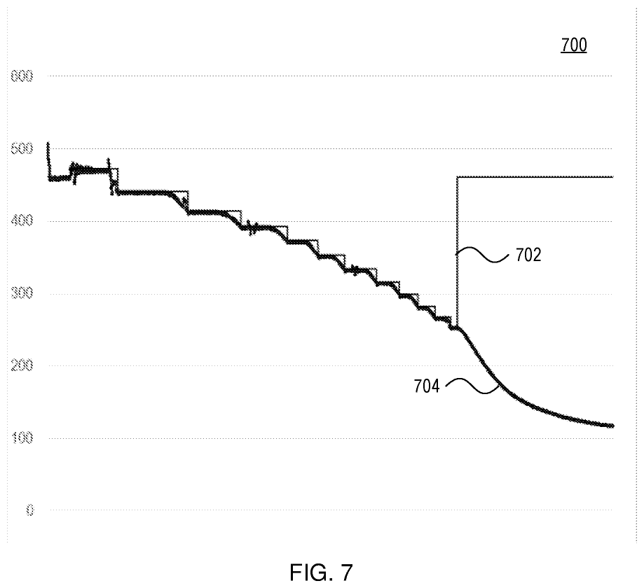

Referring now to FIG. 7, a graph 700 with an exemplary pressure curve is shown for a freeze drying process. The vertical axis shows pressure, in units of microns, and the horizontal axis marks time, with increasing time going from left to right. The set pressure 702 at various phases is shown, as is the measured temperature 704. The set temperature 702 stays the same for a pair of constant-pressure and constant-temperature phases. During the constant-pressure phase, the measured pressure 704 is held at the target value. During the subsequent constant-temperature phase, the measured pressure 704 drops. At the end of the constant-temperature phase, the measured pressure value is used as the next set pressure value for the next constant-pressure phase.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method, comprising:
performing a constant-pressure drying phase in a chamber, where a temperature of a heating tray increases;
performing a constant-temperature drying phase in the chamber, where a pressure in the chamber decreases;
alternating between additional constant-pressure drying phases and additional constant-temperature drying phases; and
halting the alternating drying phases responsive to a determination that the temperature of the heating tray has reached a maximum temperature.

2. The method of claim 1, further comprising measuring the temperature of the heating tray using a temperature sensor.

3. The method of claim 1, wherein alternating between constant-pressure drying phases and constant-temperature drying phases is triggered in a fixed-period mode.

4. The method of claim 1, wherein alternating between constant-pressure drying phases and constant-temperature drying phases is triggered in a threshold-triggered mode.

5. The method of claim 1, wherein performing the constant-pressure drying phase comprises activating a heater that causes a sample sublimation rate to match a combined evacuation rate and condensation rate.

6. The method of claim 1, wherein performing the constant-temperature drying phase comprises activating a heater that compensates for heat loss due to sample sublimation.

7. The method of claim 1, further comprising performing an initial constant-pressure phase, before the constant-pressure drying phase.

8. The method of claim 1, further comprising measuring a pressure in the chamber using a pressure sensor.

9. The method of claim 8, further comprising performing a final phase, after halting the drying phases, at the maximum temperature, where pressure in the chamber decreases to a terminal value.

10. A system, comprising:
a vacuum chamber;
a vacuum pump, configured to evacuate the vacuum chamber;
a heating tray positioned within the vacuum chamber; and
a controller, configured to control the heating tray to perform a constant-pressure drying phase in a chamber, where a temperature of the heating tray increases, to perform a constant-temperature drying phase in the chamber, where a pressure in the chamber decreases, to alternate between additional constant-pressure drying phases and additional constant-temperature drying phases, and to halt the alternating drying phases responsive to a determination that the temperature of the heating tray has reached a maximum temperature.

11. The system of claim 10, further comprising a temperature sensor configured to measure a temperature of the heating tray.

12. The system of claim 10, wherein the controller is configured to alternate between constant-pressure drying phases and constant-temperature drying phases in a fixed-period mode.

13. The system of claim 10, wherein the controller is configured to alternate between constant-pressure drying phases and constant-temperature drying phases in a threshold-triggered mode.

14. The system of claim 10, wherein the controller is configured to, during the constant-pressure drying phase, activate the heating tray to cause a sample sublimation rate to match a combined evacuation rate and condensation rate.

15. The system of claim 10, wherein the controller is configured to, during the constant-temperature drying phase, activate the heating tray to compensate for heat loss due to sample sublimation.

16. The system of claim 10, wherein the controller is further configured to perform an initial constant-pressure phase, before the constant-pressure drying phase.

17. The system of claim 10, further comprising a pressure sensor configured to measure a pressure in the vacuum chamber.

18. The system of claim 17, wherein the controller is further configured to perform a final phase, after halting the drying phases, at the maximum temperature, where pressure in the vacuum chamber decreases to a terminal value.

19. The system of claim 18, wherein each subsequent constant-pressure phase has a lower pressure setpoint than each previous constant-pressure phase.

20. A system, comprising:
a vacuum chamber;
a vacuum pump, configured to evacuate the vacuum chamber;
a heating tray positioned within the vacuum chamber;
a temperature sensor, configured to measure a temperature of the heating tray;
a pressure sensor, configured to measure a pressure of the vacuum chamber;
a controller, configured to control the heating tray to perform a constant-pressure drying phase in a chamber, where the temperature of the heating tray increases, by activating the heating tray to cause a sample sublimation rate to match a combined evacuation rate and condensation rate, to perform a constant-temperature drying phase in the chamber, where pressure in the chamber decreases, by activating the heating tray to compensate for heat loss due to sample sublimation, to alternate between additional constant-pressure drying phases and additional constant-temperature drying phases, to halt the drying phases responsive to a determination that a maximum temperature has been reached, and to perform a final phase, after halting the drying phase, where pressure in the vacuum chamber decreases to a terminal value.
